(19) United States
(12) Patent Application Publication
(10) Pub. No.: US 2024/0400144 A1
(43) Pub. Date: Dec. 5, 2024

(54) Bicycle, In Particular an Electric Bicycle

(71) Applicant: MA Micro Limited, Woking (GB)

(72) Inventors: Marjolein Deun, Woking (GB); Alexandre Phaneuf, Woking (GB); Olivier Hébert, Woking (GB); Wei-Ting Yu, Woking (GB); Tzu-Jung Huang, Woking (GB); Yu-Lin Chang, Woking (GB); Job Hendrik Stehmann, Woking (GB)

(21) Appl. No.: 18/699,001

(22) PCT Filed: Oct. 7, 2022
(86) PCT No.: PCT/NL2022/050570

§ 371 Date: Apr. 5, 2024

(30) Foreign Application Priority Data
Oct. 7, 2021 (NL) 2029347
Oct. 7, 2021 (NL) 2029348
Mar. 15, 2022 (NL) 2031280

(51) Int. Cl. B62J 6/029; B62J 6/015; B62J 6/24; B62J 6/26; B62K 3/02

(52) U.S. Cl. CPC B62J 6/029; B62J 6/015; B62J 6/24; B62K 3/02; B62J 6/26

(57) ABSTRACT

The invention relates to a bicycle (200), in particular an electric bicycle (200). The invention also relates to a light module (100) for use in a bicycle (200), in particular an electric bicycle (200) according to the invention. The invention further relates to a bicycle control unit (8) programmed to independently control a plurality of light sources (104) of at least one light module (100) for use in a bicycle (200), in particular an electric bicycle (200) according to the invention. The invention moreover relates to an assembly of at least one light module (100) according to the invention and at least one bicycle control unit (8) according to the invention.

### CROSS REFERENCE TO RELATED APPLICATIONS

This application is the United States national phase of International Patent Application No. PCT/NL2022/050570 filed Oct. 7, 2022, and claims priority to The Netherlands Patent Application No. 2029347 filed Oct. 7, 2021, The Netherlands Patent Application No. 2029348 filed Oct. 7, 2021, and The Netherlands Patent Application No. 2031280 filed Mar. 15, 2022, the disclosures of which are hereby incorporated by reference in their entireties.

### BACKGROUND OF THE INVENTION

### Field of the Invention

The invention relates to a vehicle, preferably a bicycle, in particular an electric bicycle. The invention also relates to a light module for use in a vehicle, preferably a bicycle, in particular an electric bicycle according to the invention. The invention further relates to a vehicle control unit, in particular a bicycle control unit, programmed to independently control a plurality of light sources of at least one light module for use in a vehicle, preferably a bicycle, in particular an electric bicycle according to the invention. The invention moreover relates to an assembly of at least one light module according to the invention and at least one vehicle control unit, in particular a bicycle control unit, according to the invention.

### Description of Related Art

Over the last 150 years, the bicycle has evolved to become one of the most efficient means of transportation in terms of conversion of energy into distance travelled. The efficiency of the bicycle has also been optimized to minimize the effort required by the rider. For instance, most modern bicycles include an efficient gear system to minimize rider effort. To further reduce the amount of human effort required to propel a bicycle, a variety of electric bicycles have been introduced, wherein use is made of an electromotor as auxiliary power source to assist the manpowered pedaling process. These developments have resulted in faster bicycles, which facilitates bicycling at high speeds. Because of the increased speed, bicycle riding has become increasingly more dangerous, which leads to increased risks for cyclists to become involved in accidents with other vehicles and pedestrians. This is especially true at nighttime or in the dark. Often, the reason for said accidents is that the bicycle is not highly visible to the vehicle drivers and to pedestrians, and/or that it is hard for others to anticipate to the speed and direction of the bicycle.

### SUMMARY OF THE INVENTION

It is a first object of the invention to provide an improved bicycle with an improved visibility.

It is a second object of the invention to provide an improved bicycle with a more functional visibility.

At least one of these objects can be achieved by providing a vehicle, preferably a bicycle, in particular an electric bicycle, comprising:
at least one light module said light module comprising:
   a plurality of independently controllable light sources, wherein at least one, preferably each, independently controllable light source is, directly or indirectly, controllable based on at least one light source control signal,
at least one vehicle control unit, in particular a bicycle control unit, configured to independently control at least two light sources of at least one light module by providing at least one light source control signal to said light sources and
at least one power connection, preferably controllable by said vehicle control unit, in particular said bicycle control unit, and connected to at least one independently controllable light source, for providing electric power to at least one independently controllable light source,

wherein at least two of light sources of at least one light module are oriented in different directions to emit light in different directions, such as a left emittance direction and/or a right emittance direction, and/or wherein at least two light sources of at least one light module are grouped and configured to collectively generate at least one dynamic light pattern dependent on the control of said light sources by said bicycle control unit.

The bicycle or vehicle type, such as tricycle or pedal car, according to the invention, hereinafter simply referred to as bicycle, has several advantages. Due to the application of one or more light modules, wherein at least one, preferably each, light module, comprises a plurality of independently controllable light sources, the lighting of the bicycle can be changed and adapted to the situation. This improves the visibility of the bicycle both during daytime as well as in the dark and during nighttime. As will be explained below in more detail, intensifying and/or changing the lighting of the bicycle will improve the visibility of the bicycle for road users, such as vehicle drivers and pedestrians. Moreover, this variable bicycle lighting may inform the bicycle user and may give informative feedback to the user during cycling, which also contributes to safer cycling, and which moreover is also practical in case the bicycle is parked or stored. Controlling the light sources in a centralized manner, by using at least one bicycle control unit, further contributes to controlling the light sources, independently from each other, as simple and efficient as possible. Preferably, the communication between at least one bicycle control unit and at least one light module is realized by using a bicycle bus (bicycle data bus), such as a CAN bus (Controller Area Network protocol-based bus). To this end, each light module, and in particular each controllable light source, preferably comprises an own light module control unit or light source control unit, respectively. By means of a data bus connection, such as a CAN bus connection, the control units (controllers) are allowed to communicate openly with one another. Typically, the CAN protocol includes built-in features such as a cyclical redundancy code (CRC) check that allows detection of signal errors during transmission, storage, and retrieval. Here, preferably, each light module and/or each controllable light source is assigned with a unique identifier (ID), and each light source signal preferably comprises at least one ID related segment. In this latter preferred case, the receiving controllers performs a filtering operation, and more in particular executes an acceptance test on the ID incorporated in the signal to determine if the signal, and thus the remaining signal content, is relevant to that controller. Only the controller(s) which recognized the signal will process said signal. Other controller(s) will normally the signal, which makes it rather simple, efficient and practical to control one or more light sources out of a total number of controllable light sources by using a single signal. Further advantages and embodiments of the bicycle according to the invention are described below in more detail.

In a preferred embodiment, the bicycle comprises a plurality of bicycle control units, wherein at least one bicycle control unit is formed by a central bicycle control unit or another bicycle control unit, and wherein at least one other bicycle control unit is formed by at least one light module control unit and/or light source control unit connected to said central bicycle unit, wherein said light module control unit and/or light source control unit is configured for independently controlling at least one light source of at least one associated light module, preferably based on at least one primary light source control signal received from the at least one bicycle control unit. In this embodiment, the central bicycle control unit or another bicycle control unit generates at least one light source control signal which is received as input signal by said light module control unit, wherein said light module control unit transfers said signal, in a modified or unmodified manner, to one or more controllable light sources. Here, it is for example imaginable that the user may provide lighting instructions to the central control unit, which instructions are converted into a signal readable by the light module control unit and/or the controllable light sources in order to control the desired light sources. Giving direct or indirect instructions to the central control unit by the user can e.g. be realized by means of buttons or other control elements making part of the bicycle and/or wirelessly by using an external device, in particular a portable device, such as a tablet, smartphone, or smartwatch, of a user which is configured to, directly or indirectly, wirelessly communicate with the central control unit of the bicycle. It is also imaginable that the user may define a custom and/or personalized lighting instruction, which may be uploaded, wired or wireless, to said central control unit. In that respect, the central control unit is preferably configured to transform said user defined lighting instruction into a light source control signal. It is conceivable that the bicycle comprises a separate communication control unit connected to said central control unit to allow such a wireless communication. Preferably, the at least one light module control unit is configured for converting the primary light source control signal received from the central bicycle control unit into at least one secondary light source control signal for independently controlling at least one light source. In this embodiment, it is for example imaginable that the light module control unit and/or the light source control unit adds lighting information to the primary signal, which may be rather basic, in order to generate a more comprehensive (secondary) signal, which could lead to a more sophisticated control of one or more light sources. This lighting information can for example include the timing to switch on and off a light source, the illumination period to illuminate the light source, the intensity level (illumination level) which has to be applied, and/or the colour temperature which has to be applied. This lighting information may moreover be based upon one or more external and/or situational parameters, such as bicycle related parameters, user related parameters, and/or environment related parameters. Hence, by using a light module control unit and/or light source control unit a more intelligent bicycle lighting can be obtained. Preferably, at least one light module control unit (if applied) makes part of at least one light module. Preferably, at least one light source control unit (if applied) makes part of at least one light source.

In a preferred embodiment, at least one bicycle control unit is configured to generate at least one light source control signal which comprises at least one dynamic light pattern definition. This will result in allowing the one or more light sources of at least one light module to produce a dynamic light pattern. This is an emitted image which varies over time. This variation can relate to switching on and off specific light sources, sequentially, simultaneously, randomly or partially overlappingly in time. This variation can also, optionally additionally, relate to varying the illumination level and/or colour temperature of one or more light sources. Such a dynamic pattern can be seen by persons surrounding the bicycle and/or by a user riding the bicycle. Such a dynamic pattern will be eye-catching which will improve the safety of the bicycle during cycling (or during parking), and may moreover provide informational feedback to the user, which feedback may, for example, be related to the lock status of the bicycle and/or parking location of the bicycle. Preferably, at least two of light sources of at least one light module that are oriented in different directions to emit light in different directions are configured to be controlled independently of one another. As such, the direction of light emittance may be arbitrarily chosen. This may for example be of benefit when unlocking the bicycle. When a user unlocks the bicycle, he or she is typically standing alongside the bicycle. By emitting light in a sideward direction the user may be attended of the fact that the bicycle is unlocked. A similar benefit holds when locking the bicycle. To this end it is imaginable that the light sources are configured to emit a predefined light emittance pattern and/or predefined light emittance direction. In respect of unlocking and locking, it is conceivable that the light emittance patterns are substantially different, preferably opposite or the like. This may clearly indicate to a user whether the bicycle is locked or unlocked. The dynamic light pattern may be emitted in a single direction or in multiple directions (simultaneously and/or sequentially). It is imaginable a plurality of dynamic light patterns is emitted by light sources of at least one light module, wherein the different dynamic patterns may be identical, mirrored, or mutually different. The emittance direction of the light sources, and in particular of a dynamic light pattern emitted by said light sources, may be forward direction and/or a rear direction and/or at least one lateral direction and/or a downward direction (as seen from a top view of the bicycle). Preferably, and in general, one of more controllable light sources of at least one light module are projected in downward direction, more preferably to realize a ground projection is preferably located laterally and/or in front of the bicycle (as seen from a top view of the bicycle). Optionally, the aforementioned dynamic light pattern is directed in downward direction to create said ground projection (floor projection), wherein the ground projection is preferably located laterally and/or in front of the bicycle (as seen from a top view of the bicycle). This may e.g. be beneficial to indicate safe boundaries for the bicycle during cycle to inform other road users and/or may be used as user display to inform the user about one or more, preferably bicycle and/or environment related, characteristics, such as battery status and/or ambient temperature. Alternatively and/or additionally, the said downwardly directed controllable light sources may be used to project on the floor (on the ground, or on the road) journey related information and/or navigation instructions/information allowing the cyclist to process instructions faster and keep his/her attention on the road. Examples of such projectable pieces of information are turn indicator arrows, a distance to the next turn, the current speed, the travelled distance, the travelled time, to estimated time of arrival, the remaining travel time, the remaining travel distance, upcoming traffic lights related information, and combinations thereof. Optionally, the bicycle comprises a projection screen, preferably attached to a bicycle frame and/or a bicycle handlebar of the bicycle, wherein at least a number of controllable light sources of at least one light module are directed towards said projection screen to project information, such as bicycle and/or navigation related information, on said screen. In this manner, the bicycle is provided with a head-up display. Although the bicycle may be provided with a navigation system, it is typically preferred that a navigation application is installed on a portable device, such as a smartphone or smartwatch, carried by the user, which communicates, in a wired or wireless manner, and directly or indirectly, with at least one bicycle control unit to subsequently control at least one light module. Preferably, at least two light sources of at least one light module are grouped, preferably in an array, and configured to collectively generate at least one dynamic light pattern based upon said at least one light source control signal which comprises at least one dynamic light pattern definition. This coherent orientation of light sources will commonly contribute to realizing a coherent dynamic light pattern. The dynamic light pattern may provide information to the user about e.g. the bicycle, and/or the bicycle status, and/or changed bicycle settings, etcetera. The dynamic light pattern may for example represent at least one of the following light patterns: an updating light pattern, a power on light pattern, a power off light pattern, a steering direction, a locking light pattern, an unlocking light pattern, a feedback light pattern.

Preferably, at least one light source control signal comprises light source specific instructions for at least one specific (predefined or selected) light source, such as light intensity related instructions and/or light colour related instructions, which are readable by said specific light source. This will commonly increase the freedom of dynamically control a controllable light source. Varying the colour temperature typically leads to varying colours, including colours which deviate from the white colour. Preferably, at least one light source of at least one light module is a multi-colour light source, such as a multi-colour light emitting diode (LED).

At least one light source control signal preferably comprises a string of light source specific instructions, wherein at least two, preferably each, independently controllable light source(s) retrieves and/or extracts a predefined instruction associated with said light source out of the string of light source specific instructions. Such a (combined) control signal can, for example, be generated and communicated between at least one bicycle control unit and said light sources by using a data bus, such as a CAN bus.

It is imaginable that at least two independently controllable light sources have a mutually different size. It is imaginable one or more controllable light sources are configured to adjust the light intensity and/or the colour temperature and/or the colour. At least two independently controllable light sources may simultaneously produce mutually different light intensities and/or mutually different colour temperatures and/or mutually different colours. It is conceivable that at last one independently controllably light source is a daytime light source, and at least one independently controllable light source is a nighttime light source. The nighttime light source may have a greater intensity compared to the daytime light source. The daytime light source and the nighttime light source may be controlled independently, and may emit light simultaneously, and/or may even be integrated with each other. The daytime light source may increase the visibility of the rider to external parties of the traffic. The nighttime light source may for example additionally at least partially light up a road. To this end, the central control unit may control either of the daytime light source and/or the nighttime light source based on an instantaneous time.

In a preferred embodiment, at least two independently controllable light sources are directed in substantially opposing directions, preferably in a left-handed oriented direction and in right-handed oriented direction, respectively. Such opposing directions improve the visibility of the visual signals emitted by the bicycle. Moreover, this embodiment is also suitable to selectively illuminate in one direction and/or in other direction, such as in the left-handed oriented direction and in the right-handed oriented direction. This allows the bicycle for example to use one more light modules as flash light modules to indicate an anticipated direction of the bicycle, preferably by alternately switching and off one or more (selective) light sources to realize a blinking effect (flash light effect). The flash light direction can be set and dictated by the used and/or which direction can be determined user-independently, for example based upon one or more bicycle parameters, such as e.g. cycling speed combined with a rotation level of a steering handle of the bicycle, and/or e.g. based upon navigation instructions provided by the bicycle and/or a portable device.

Preferably, the bicycle comprises a plurality of light modules, each light module comprising a plurality of independently controllable light sources. Different light modules may have different functionalities. For example, a rear light module, a front light module, a lateral light module, and/or a flash light module may be used. It is however imaginable that two or more of said functionalities are combined and integrated within a single light module.

It is conceivable that at least one light module comprises at least one diffusor, for diffusing light emitted by at least one light source. Said diffusor may comprise a plurality of diffusing elements, each for diffusing light emitted by a particular light source, or the diffusor may comprise a larger disusing element, wherein said diffusing element is configured for diffusing light emitted by two or more light sources. However, a combination thereof is also conceivable. By diffusing the light emitted a more evenly lit up surface may be provided. It is preferred that the diffusivity degree of the diffusor is adaptable, such that the degree of light diffusion may be adjusted. Moreover, by using a diffusor it may be more convenient to direct the light from a light source into a preferred direction. That is, said diffusor may allow for directing the light emittance direction of an upwardly oriented light source in e.g., a backward oriented direction. This may allow for more arbitrary placement of the light sources and thus may allow for more design freedom.

It is imaginable that at least one light module, preferably the rear light module, comprises a stop light. Preferably, said stop light comprises at least one independently controllably light source, although more is conceivable. For a better distinction between the stop light and the regular lighting, it is preferred that said stop light is visually distinct, such as separated, from the regular riding light. This may be achieved by means of e.g., a physical barrier between the regular light of the light module and the stop light of the light module. But it may alternatively be achieved by means of a separate light diffusor. However, having a higher light intensity may also allow for distinguishing between the regular light and the stop light.

Preferably, at least two light sources of at least one light module are grouped, preferably in an array, and wherein light sources of said group of light sources are independently, preferably as group, controllable by at least one bicycle control unit or by a plurality of bicycle control units. In case multiple bicycle control units are used for controlling the controllable light sources, these control units may be connected in series and/or may act dependently on each other. However, it is also imaginable that at least two control units are configured to, independently from each, control one or more controllable light sources. In a preferred embodiment, a number of the plurality of independently controllable grouped light sources is arranged to form at least a part of a circle and/or at least a part of a polygon, such as a triangle, square, pentagon, hexagon, or octagon. Alternatively and/or additionally, a number of grouped independently controllable grouped light sources may be arranged to form a character, such as a letter, like the letters “V”, “M”, “S”, or “X”, or even a combination of letters, such as words. Preferably, at least one light module comprises a plurality of groups of independently controllable light sources, wherein one group of light sources encloses at least one of group of light sources. This could e.g. lead to a centered group which is enclosed (circumvented) by a peripheral group. This concentric orientation of groups could be used to further adapt the overall illumination pattern emitted in one or more directions, for safety and/or functional reasons, and allows the user and/or the bicycle e.g. to switch between a regular beam and a more intensive high beam. It is imaginable that at least two, preferably at least three, light sources of said plurality of independently controllable grouped light sources are oriented in different emittance directions, wherein at least two emittance directions preferably enclosed an angle of between 60 and 120 degrees. For example, it is imaginable that a front light module and/or rear light module emits light both in a front direction and at least two lateral (sideward) directions. Hence, at least one light module may comprise a plurality of groups of independently controllable light sources, wherein the main emittance direction of at least two groups preferably mutually differs. Although at least two groups of independently controllable light sources of at least one light module can be positioned closed, and optionally adjacently to each other, it is also imaginable that at least two of such groups are mutually separated at least by at least one mechanical part, in particular frame part, of the bicycle. Here, the groups may be positioned at separate sides of the same mechanical part, in particular the same frame part, or may be positioned at different mechanical parts, in particular different frame parts. The emittance patterns generated by at least two groups of independently controllable light sources may at least partially overlap and/or coincide.

Preferably, the at least two independently controllable light sources are arranged on a substrate, such as a printed circuit board, wherein said substrate is a curved substrate, such as single-curved, or plural-curved, in particular double-curved, preferably wherein said curved substrate at least partially follows a curvature of a part of a frame of the bicycle, such as a seat tube and/or a top tube.

As indicated above, the bicycle control unit may be configured to generate at least one light source control signal based upon input received from a user and/or a portable device carried by said user. Such input can be of various nature, and may e.g. include navigation instructions, manually controlling lights by the user, directly via a control element of the bicycle, which is typically positioned on a handlebar of the bicycle, and/or via a portable user device, such as a smartphone or smartwatch, which may communicate with at least one bicycle control unit. It is even conceivable that the user is allowed to control the controllable light sources by using one or more voice commands. These voice commands may be recorded (a bicycle microphone will be needed in this case) and/or processed directly by the bicycle, and/or may recorded and/or processed by a portable user device which is configured to communicate with the bicycle. Alternatively or additional, the bicycle control unit is configured to generate at least one light source control signal based upon at least one bicycle related characteristic, such as the bicycle speed, the bicycle acceleration, the bicycle steering direction, the extent of the bicycle steering direction, the status of a bicycle lock (locked versus unlocked), and the status a bicycle power source. Alternatively, or additionally, the bicycle control unit is configured to generate at least one light source control signal based upon at least one environmental related characteristic, such as the temperature, the humidity, the CO₂ content, and the ambient light level.

Preferably, the bicycle comprises at least one power source, such as a battery, to provided power to said at least one power connection. Typically, the power source is a rechargeable power source. Optionally, multiple power sources may be used in the bicycle. Preferably, each bicycle control unit and/or each light source is powered via at least one (powered) power connection. Preferably, each light source is formed by a light emitting diode, such as LED, OLED, and/or by a laser diode. At least one light source may be a single-colour light source. At least two single-colour light sources may have mutually different colours. Preferably, at least one light source is a multi-colour light source, such as a multi-colour LED, for example an RGB LED, which may comprise a plurality a light source modules of different colour, such as a red light source module, a green light source module, and a blue light source module. Mixing light of different colours may result in a different resulting colour, which can be used to generate any colour of choice. Light emitting diodes are relatively energy efficient and have a long lifespan, while producing no (notable) heat. Optionally, other light sources may be used as well.

In a preferred embodiment, the light module comprises at least one, preferably at least partially transparent or translucent, light module housing, said housing defining at least one accommodating space for at least partially accommodating one or more light sources. Typically, such a housing is at least partially composed of a polymer material and/or or glass. The housing may be a coloured housing, such as a red housing, which may be favourable for the housing of a rear light (module).

In a preferred embodiment, the bicycle comprises a frame comprising a plurality of interconnected frame elements, which frame elements are preferably formed by at least a seat tube element, a top tube element, a down tube element, a head tube element, at least one seat stay, at least one handlebar, and/or at least one chain stay. The tube elements typically define at least a part of a stationary frame of the bicycle. Typically, these tube elements are mutually welded and are not configured to be moved with respect to each other to keep the frame as simple and as rigid as possible. Preferably, at least one, and more preferably each, light module is attached or affixed to the stationary frame of the bicycle, and thus preferably not to movable bicycle parts, like the handlebar This attachment to the stationary frame is in particular favourable for a front light module, a rear light module, and a flash light module (if applied), as the emittance direction will be predefined and constant in this case. Preferably, at least one light module is at least partially received by at least one frame element, in particular the top tube element and/or the seat tube element. More preferably, opposing end section of the top tube element are provided with a front light module and a rear light module, respectively. In between one or more additional light modules may be present. Preferably, at least a part of at least one frame element, in particular the top tube element and/or bottom tube element, comprises at least one recessed channel, for accommodating therein the at least one strip shaped light module. More preferably, said recessed channel is provided on an exterior side of the top tube element and/or bottom tube element, and wherein the at least one light module accommodated in said recessed channel is at least partially covered by a substantially transparent or translucent covering material, preferably such that an exterior surface of said covering material is substantially flush with respect to an exposed adjacent exterior surface of the top tube element and/or bottom tube element. Such as flush orientation secures a compact design of the bicycle and moreover prevents easy damaging of the strip shaped light module(s).

The bicycle may comprise at least one sensor, preferably a plurality of sensors, wherein at least one bicycle control unit, preferably a light module control unit, is configured for generating at least a part of at least one light source control signal based on data from the at least one sensor. Examples of such sensors are a light sensor, a humidity sensor, an acceleration sensor, a speed sensor, a tilt sensor, a shock sensor, a vibration sensor, a steer rotation sensor, a CO₂ sensor, a O₂ sensor, a humidity sensor, and a temperature sensor, and/or combinations thereof. A plurality one or more of these or other sensors may be applied in the bicycle. For example, in case a light sensor detects that the environmental brightness level drops below a predefined amount of Lumens, at least one light source control signal may be generated to switch one or more bicycle lights on and/or to brighten already switched on lights; and/or when the environmental brightness level exceeds a predefined amount of Lumens, at least one light source control signal may be generated to switch one or more bicycle lights off. Another example is that in case an acceleration sensor or tilt sensor of the bicycle detects a rapid stop and/or emergency stop of the bicycle, at least one light source control signal may be generated to switch one or more bicycle lights on, and/or to brighten and/or flash one or more already switched on lights to warn the environment, and/or to change colour of one or more bicycle lights. A further example is that in case a speed sensor detects that the bicycle speed exceeds a predefined threshold speed, at least one light source control signal may be generated to e.g. to switch on one or more bicycle lights, and/or to brighten one or more already switched on lights, and/or to flash one or more bicycle lights to warn the environment. Yet a further example is that in case the steer rotation sensor and/or tilt sensor detects that the bicycle is steered in a certain direction, at least one light source control signal may be generated to e.g. to switch on one or more bicycle lights, and/or to adapt the illumination pattern of at least one bicycle light, such as a rear light and/or front light, such that the steering direction is visualized for the direct environment (traffic participants). This latter visualization can be done e.g. by flashing said light(s) and/or by creating a recognizable light pattern, such as an arrow recognizable for other traffic participants, optionally in a different or distinctive colour. Gas sensors, like a CO₂ sensor and a O₂ sensor, typically act as an electronic nose. These gas sensors and/or a temperature sensor or a humidity sensor, may be used to monitor the direct environment and to warn the bicycle user in case one or more critical thresholds are exceeded, such as temperature limit and/or humidity limit (to warn the bicycle user for slippery roads and/or to warn the bicycle for severe weather conditions), a O₂ limit (to warn the bicycle user in case an oxygen poor environment), etcetera. More sophisticated algorithms based upon the data collected by a plurality of sensors in order to generate one or more light source control signals may also be applied. For example, a steering direction related control signal may only be generated in case both the steering direction sensor and the speed sensor exceed a predefined threshold value. More in general, according to this embodiment, at least one light source control signal is generated in case each of a plurality of sensors exceeds a predefined threshold value. The light source control signal may be generated directly after detection of an exceeding of at least one threshold value by at least one sensor. However, it is also imaginable that this at least one signal is created after a predefined delay and/or in case the threshold excess lasts for a predefined amount of time, such as e.g. 3, 5, or 10 seconds. As will be clear from this paragraph various alternative embodiments are conceivable in this respect.

Typically, the bicycle comprises foot pedals, wherein said pedals are, directly or indirectly, connected to the crankset of the bicycle for propelling the bicycle. Preferably, the bicycle is a pedal operable electric bicycle, also referred to as e-bike, pedelec, and speed pedelec. Preferably, the bicycle comprises at least one electromotor to drive at least one wheel of the bicycle. Typically, the bicycle comprises a pedal-operated manpower driven system and an electromotor driven system in parallel to each other, wherein at least one bicycle control unit is configured to control the output of the electromotor driven in response to a pedal depressing force of the manpower driven system.

The invention also relates to a light module for use in a vehicle, such as a bicycle, in particular an electric bicycle according to the invention. The invention further relates to a bicycle control unit programmed to independently control a plurality of light sources of at least one light module for use in a bicycle, in particular an electric bicycle according to the invention. Moreover, the invention relates to at least one light module according to the invention and at least one bicycle control unit according to the invention, wherein the light module(s) is/are preferably connected to said at least one bicycle control unit.

The invention is further illustrated by means of the non-limitative set of clauses presented below.

1. Light module for bicycle lighting, preferably with lateral indicator light function by means of a respective light module, such as by means of a frame tube light module, a rear light module and/or a front light module, for providing a lateral indicator light function on a bicycle with a frame comprising a number of tube elements and an on-board computer, such as a bicycle control unit or central bicycle control unit, the light module comprising:
at least one light source oriented to the left, such as a left emittance direction, which is independently controllable from the on-board computer,
at least one light source oriented to the right, such as a right emittance direction, which is independently controllable from the on-board computer,
power connection means for supplying electrical power to a respective light source from a battery and/or the on-board computer,
data connection means for connecting the light sources to the central on-board computer of the bicycle in order to deliver control signals, such as a light source control signal, from the on-board computer, such as a bicycle control unit, for the lateral indicator light function.

2. Light module according to Clause 1, embodied as a frame tube element light module to be arranged against a frame tube element, such as against a lateral outer face thereof, providing a lateral indicator light function from a location on the frame tube element.

3. Light module according to Clause 2, wherein the light module comprises an elongate body or housing, comprising an elongate light source or a series of light sources distributed over the elongate body or housing.

4. Light module according to one or more of the preceding clauses, wherein the at least one light source oriented to the left and/or the at least one light source oriented to the right is arranged in a bicycle lighting module providing a further lighting function on the bicycle such as a front light module or a rear light module.

5. Light module according to Clause 4, comprising
a bicycle lighting control module, such as a light module control unit, for receiving control signals, such as a primary light source control signal from an on-board computer, such as the central bicycle control unit, of the bicycle and, on the basis of the control signals, for switching, such as switching on and switching off, a supply current to at least a number of independently controllable light sources such as LEDs, or independently controllable groups of light sources,
data connection means for connecting the bicycle lighting module or the bicycle lighting control module thereof to the central on-board computer of the bicycle, preferably comprising data connection means to a respective light source in order to deliver control signals for the lateral indicator light function,
wherein the bicycle lighting control module is designed to convert control signals, such as the primary control signals, from the on-board computer, such as the central bicycle control unit, to control signals for a respective independently controllable light source, such as secondary light source signals.

6. Bicycle lighting module according to one or more of the preceding clauses, wherein each of the at least one independently controllable light sources has a light emission in accordance with a directional positioning of each of the number of independently controllable light sources.

7. Bicycle lighting module according to one or more of the preceding clauses, wherein at least some of the number of independently controllable light sources are arranged substantially in a first plane while others thereof are arranged substantially in a second plane.

8. Bicycle lighting module according to one or more of the preceding clauses, wherein at least some of the number of independently controllable light sources are arranged substantially in a ring shape, preferably a portion thereof or the entirety thereof.

9. Bicycle lighting module according to Clause 8, wherein the substantially ring-shaped arrangement is arranged substantially adjacent to an end face of a frame tube, such as a saddle tube, preferably arranged substantially horizontally or substantially adjacent to an end face of a top tube, preferably arranged substantially vertically.

10. Bicycle lighting module according to Clause 8 or 9, wherein various of the number of independently controllable light sources in the substantially ring-shaped arrangement are controllable by group.

11. Bicycle lighting module according to one or more of the preceding clauses, wherein one of the number of independently controllable light sources extends in a second plane substantially in the direction of travel of the bicycle relative to a first plane substantially perpendicular to the direction of travel. 12. Bicycle lighting module according to Clause 11, wherein a first one of the number of independently controllable light sources is located on the left-hand side of the frame and a second one of the number of independently controllable light sources is located on the right-hand side of the frame.

13. Bicycle lighting module according to one or more of the preceding clauses, wherein the conduction means are designed as at least one printed circuit board or as at least one flexible conductor, preferably comprising a separate printed circuit board for light-emitting means in one plane at an angle or substantially perpendicular to another plane.

14. Bicycle lighting module according to one or more of the preceding clauses, wherein the bicycle lighting control module comprises processing means for converting instructions comprising dynamic lighting patterns to patterns of switching so that the dynamic lighting patterns are reproducible by means of the number of independently controllable light sources.

15. Bicycle lighting module according to one or more of the preceding clauses, wherein the bicycle lighting control module is designed to receive definition information for a lighting pattern from the on-board computer of the bicycle.

16. Bicycle lighting module according to one or more of the preceding clauses, wherein the connection means comprise a connector for connecting to the on-board computer of the bicycle thereby by means of a wire connection, such as a network connection.

17. Bicycle lighting module according to one or more of the preceding clauses, wherein the connection means comprise a wire connection to the on-board computer which runs via the interior of at least one frame tube.

18. Bicycle lighting module according to one or more of the preceding clauses, comprising lens means for guiding emitted light substantially in the direction of emission of the respective independently controllable light source.

19. Bicycle lighting module according to one or more of the preceding clauses, wherein at least some of the number of independently controllable light sources are arranged in a curved plane that extends substantially congruently along a tube element of the frame of the bicycle.

20. Bicycle lighting module according to Clause 19, wherein the tube element is a saddle tube or a top tube.

21. Bicycle lighting module according to one or more of the preceding clauses, wherein the control signals comprise intensity information for switching to a higher light intensity, such as by means of a light source with a higher light output or delivering a higher power to at least some of the number of independently controllable light sources.

22. Bicycle lighting module according to one or more of the preceding clauses, wherein the connection means 5 comprise distinct wires or poles for respective functions comprising ground, shielding, power, network or signal 1 and network or signal 2.

23. Bicycle lighting module according to one or more of the preceding clauses, wherein at least one of the at least one light source is provided with a control signal processing unit for processing control signals, such as for executing a respective portion of received control signals and/or sending remaining control signals on to a further light source.

24. Bicycle with lighting module according to one or more of the preceding clauses and bicycle on-board computer connected to a number of component systems of the bicycle, wherein the on-board computer is designed to compile control signals for the light module on the basis of status information for the bicycle which is compiled by the bicycle on-board computer on the basis of input from at least one of a number of component systems and/or user input from a rider, such as by means of a pedal movement or operating an operating means, such as a button.

25. Bicycle according to Clause 24, wherein the status information from which the on-board computer is designed to compile the control signals relates to a blinker light status such as on the basis of the user input from the rider of the bicycle.

26. Bicycle according to Clause 24 or 25, wherein the status information relates to a brake status of the bicycle, such as determined on the basis of a delay in a drive motor thereof.

27. Bicycle lighting module, preferably with multidirectionality, such as a rear light module and/or a front light module, for providing bicycle lighting with multidirectionality on a bicycle with a frame comprising a number of tube elements, the bicycle lighting module comprising:
at least a number of independently controllable light sources,
a bicycle lighting control module, such as a bicycle control unit, for receiving control signals, such as a light source control signal, from an on-board computer, such as a central control unit, of the bicycle and, on the basis of the control signals, for switching, such as switching on and switching off, a supply current to at least a number of independently controllable light sources such as LEDs, or independently controllable groups of light sources,
power connection means for supplying electrical power to the bicycle lighting module,
data connection means for connecting the bicycle lighting module or the bicycle lighting control module thereof to the central on-board computer of the bicycle, preferably comprising data connection means to a respective light source in order to deliver control signals for the lateral indicator light function,
wherein the bicycle lighting control module, such as the bicycle control unit, in particular the light module control unit, is designed to convert control signals, such as primary control signals from the on-board computer, such as the central bicycle control unit, to control signals for a respective independently controllable light source, such as secondary control signals.

28. Bicycle lighting module according to Clause 27, wherein each of the at least one independently controllable light sources has a light emission in accordance with a directional positioning of each of the number of independently controllable light sources.

29. Bicycle lighting module according to Clause 27 or 28, wherein at least some of the number of independently controllable light sources are arranged substantially in a first plane while others thereof are arranged substantially in a second plane.

30. Bicycle lighting module according to Clause 27, 28 or 29, wherein at least some of the number of independently controllable light sources are arranged substantially in a ring shape, preferably a portion thereof or the entirety thereof.

31. Bicycle lighting module according to Clause 30, wherein the substantially ring-shaped arrangement is arranged substantially adjacent to an end face of a frame tube, such as a saddle tube, preferably arranged substantially horizontally or substantially adjacent to an end face of a top tube, preferably arranged substantially vertically.

32. Bicycle lighting module according to Clause 30 or 31, wherein various of the number of independently controllable light sources in the substantially ring-shaped arrangement are controllable by group.

33. Bicycle lighting module according to one or more of the preceding clauses, wherein one of the number of independently controllable light sources extends in a second plane substantially in the direction of travel of the bicycle relative to a first plane substantially perpendicular to the direction of travel.

34. Bicycle lighting module according to Clause 33, wherein a first one of the number of independently controllable light sources is located on the left-hand side of the frame and a second one of the number of independently controllable light sources is located on the right-hand side of the frame.

35. Bicycle lighting module according to one or more of the preceding clauses, wherein the conduction means are designed as at least one printed circuit board or as at least one flexible conductor, preferably comprising a separate printed circuit board for light-emitting means in one plane at an angle or substantially perpendicular to another plane.

36. Bicycle lighting module according to one or more of the preceding clauses, wherein the bicycle lighting control module comprises processing means for converting instructions comprising dynamic lighting patterns to patterns of switching so that the dynamic lighting patterns are reproducible by means of the number of independently controllable light sources.

37. Bicycle lighting module according to one or more of the preceding clauses, wherein the bicycle lighting control module is designed to receive definition information for a lighting pattern from the on-board computer of the bicycle.

38. Bicycle lighting module according to one or more of the preceding clauses, wherein the connection means comprise a connector for connecting to the on-board computer of the bicycle thereby by means of a wire connection, such as a network connection.

39. Bicycle lighting module according to one or more of the preceding clauses, wherein the connection means comprise a wire connection to the on-board computer which runs via the interior of at least one frame tube.

40. Bicycle lighting module according to one or more of the preceding clauses, comprising lens means for guiding emitted light substantially in the direction of emission of the respective independently controllable light source.

41. Bicycle lighting module according to one or more of the preceding clauses, wherein at least some of the number of independently controllable light sources are arranged in a curved plane that extends substantially congruently along a tube element of the frame of the bicycle.

42. Bicycle lighting module according to clause 41, wherein the tube element is a saddle tube or a top tube.

43. Bicycle lighting module according to one or more of the preceding clauses, wherein the control signals comprise intensity information for switching to a higher light intensity, such as by means of a light source with a higher light output or delivering a higher power to at least some of the number of independently controllable light sources.

44. Bicycle lighting module according to one or more of the preceding clauses, wherein the connection means 5 comprise distinct wires or poles for respective functions comprising ground, shielding, power, network or signal 1 and network or signal 2.

45. Bicycle lighting module according to one or more of the preceding clauses, wherein at least one of the at least one light source is provided with a control signal processing unit for processing control signals, such as for executing a respective portion of received control signals and/or sending remaining control signals on to a further light source.

46. Bicycle with bicycle lighting module according to one or more of the preceding clauses and a bicycle on-board computer, such as a bicycle control unit, connected to a number of component systems of the bicycle, wherein the on-board computer is designed to compile control signals, such as a light source control signal, for the bicycle lighting module on the basis of status information for the bicycle which is compiled by the bicycle on-board computer on the basis of input from at least one of a number of component systems and/or user input from a rider, such as by means of a pedal movement or operating an operating means, such as a button.

47. Bicycle according to Clause 46, wherein the status information from which the on-board computer is designed to compile the control signals relates to a blinker light status such as on the basis of the user input from the rider of the bicycle.

48. Bicycle according to Clause 46 or 47, wherein the status information relates to a brake status of the bicycle, such as determined on the basis of a delay in a drive motor thereof.

### BRIEF DESCRIPTION OF THE DRAWINGS

The terms Fig., Figs., Figure, and Figures are used interchangeably in the specification to refer to the corresponding figures in the drawings.

The present invention will hereinafter be further elucidated based on the following figures, wherein:

FIG. 1 shows a schematic view of light module according to a non-limitative embodiment of the present invention;

FIG. 2a shows a separate perspective view of the light module as shown in FIG. 1;

FIG. 2b shows a cross-sectional view of the light module in FIG. 2a along line section A-A′;

FIG. 3 shows a schematic exploded view of the light module as shown in FIGS. 1 and 2;

FIG. 4 shows a part of a bicycle frame for receiving a light module according to an alternative embodiment as the one shown in FIGS. 1-3;

FIG. 5 shows an exploded view of a light module according to a further alternative embodiment as those shown in FIGS. 1-3 and FIG. 4;

FIG. 6 shows a part of a bicycle frame for receiving a light module according to yet a different embodiment according to the invention;

FIG. 7 shows a schematical overview of a bicycle control unit according to the invention;

FIGS. 8a and 8b show a cross sectional view of a frame part comprising a light module according to the invention;

FIG. 9 shows a light module according to yet another embodiment according to the invention; and

FIG. 10 shows a schematic overview of a bicycle according to the invention.

### DESCRIPTION OF THE INVENTION

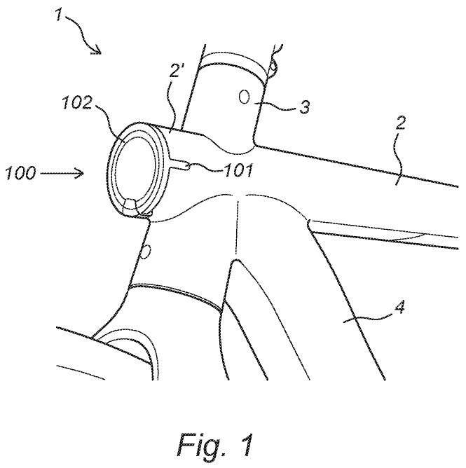

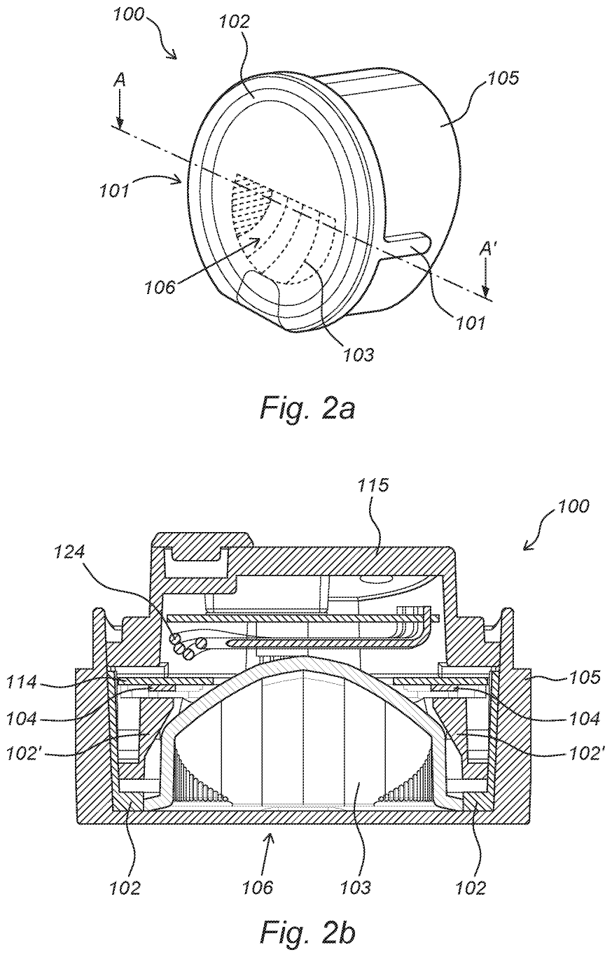

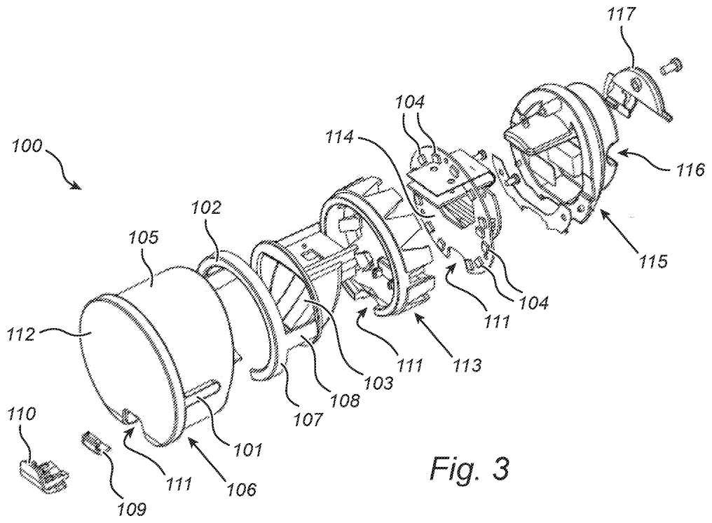

FIG. 1 shows a first non-limitative embodiment of the bicycle 1 comprising at least one light module 100 according to the invention. The bicycle 1 comprises a frame which frame preferably comprises an upper tube 2, a head tube 3, and a bottom tube 4. This figure further shows a frame element 2′ which is an extension of the upper tube 2. It is conceivable that the light module 100 according to the invention is at least partially housed within a frame part, preferably said frame element 2′. The light module 100 as shown in this figure forms a front light module, however the invention is not limited to this exemplary embodiment. The light module according to this non-limitative embodiment comprises at least one light emitting surface 101 which emits light in a substantially lateral direction. The light module 100 such as provided in this figure is shown in more detail in FIG. 2a. The light module 100 preferably comprises at least two light emitting surfaces 101 which are configured for emitting light in different directions, in particular a left emittance direction and/or a right emittance direction when one or more light sources 104 (not shown) are turned on. The module 100 further comprises a housing 105 which may preferably be at least partially composed out of a substantially translucent and/or transparent material. The light module 100 comprises one main light beam 106 which may be emitted via at least one reflecting module 103 when one or more light sources 104 are turned on. The light module 100 may also comprise a substantially circular light emitting surface 102. In the cross-sectional view of the light module 100 as shown in FIG. 2b, said circular light emitting surface 102 is indirectly in contact with the light sources 104 via a lens body 102′. Said lens body 102′ may direct light emitted via the light sources 104 to the circular light emitting surface. Said circular light emitting surface 102 may also be formed differently and is therefore not limited to this particular shape. In addition to the circular light emitting surface 102 a main light beam 106 may be present, such a central main light beam 106 may extend from the light module 100 via a reflector 103. The figure further indicates that the housing 105 comprises a rear lid, such as a module holder 115 for holding components. One of said components may for example be cables 124 for the connector of the module 100. FIG. 3 depicts an exploded view of the light module 100 as shown in FIGS. 1 and 2a, 2b. The outside of the light module 100 is at least partially formed by the housing 105. Said housing 105 comprises a mounting space 111, which is configured to receive a bolt or nut, such that the light module 100 may be attached to a part of the bicycle 1. The mounting space 111 is recessed with respect to a frontal surface 112. In order to protect the bolt or nut in the mounting space 111, a first covering element 109 and second covering element 110 are provided. Preferably, an exterior of the second covering element 110 is substantially flush with an adjacent exterior portion of the casing 105. The light emitting surface 101 which is sidewards is slightly protruding with respect to the side surface of the casing 105. This allows said sideward emitting surface 101 to be substantially flush with the frame portion 2′ of the bicycle 1. A lens module 107 may be provided onto or in the casing 105, which may provide a convex or concave function to the light emitted by the light sources 104. Said lens module 107 may for instance comprise a sideward portion 108 which fulfils a similar function for a light module directed sidewards, for example for providing light for the light emitting surface 101. The lens module 107 may further comprise a substantially circular portion 102 which may form part of the circular light emitting surface 102. The housing may further comprise a lock ring 113, which may be configured for locking a printed circuit board 114 into a predefined position with respect to the housing 105. Said lock ring further may be provided with a recess 111 which corresponds to the shape of the mounting space 111 such as to allow the bolt or nut to pass. The printed circuit board 114 may be provided with a plurality of light sources 104, preferably a plurality of independently controllable light sources, such as Light Emitting Diodes (LED's). Said printed circuit board 114 may be locked into position by the lock ring 113 to a module holder 115. Said module holder 115 may have different functionalities. First of all, said module holder 115 may be configured for holding various electronic components, such as a connector. Said connector may for example provide the light module 100 with power and as such form a power connection for the light module 100. Additionally, said connector may be configured for communicating a light source control signal to at least one of the light sources 104. It is preferred that the connector is based on a Controller Area Network bus (CAN bus), comprises for example five connections, such as a first CAN, second CAN, a ground, power, and a shielding. The connector may as such be mounted on the module holder 115 in a recessed portion 116 on a back side thereof. In order to rigidly mount the connector to the light module 100, a bracket 117 may be used to further secure the connector, when installed, to the module holder 115. A part of said module holder 115 may form a part of the outer surface of the light module 100, preferably a part of the back side thereof.

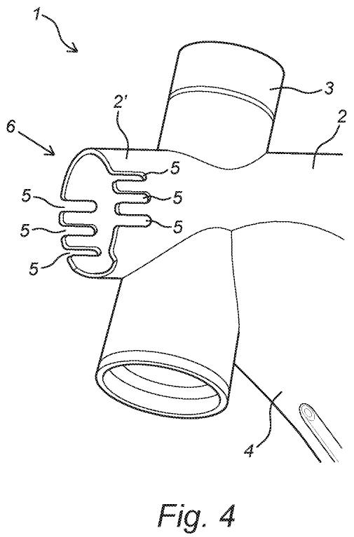

FIG. 4 shows a part of a frame of a bicycle 1 according to the invention. The frame is configured for receiving a light module 100 according to the invention. To this end, a frame element 2′ comprises an opening 6 which is dimensioned such that it can receive and/or house a light module 100. The frame element 2′ in this particular embodiment is an extension part of the upper tube 2, and also connected to the bottom tube 4, and to the head tube 3. The frame element 2′ may be integral part of the upper tube 2, or may be separately attached to the front side of the frame. The frame element 2′ is provided with a number of recesses 5. Said recesses 5 are configured for receiving a light emitting surface 101 of the light module 100. Preferably, the light emitting surface or surfaces 101 of the light module corresponds to the recesses 5 of the frame element 2′. Although this frame depicts three recesses 5 at the left side and right side of the frame, any number or shape may be chosen for the recesses 5. The choice of the amount of recesses 5, and the shape of the recesses 5 is therefore a design related aspect. The invention relates, inter alia, to the sidewards directed light emitting surface 101 as such.

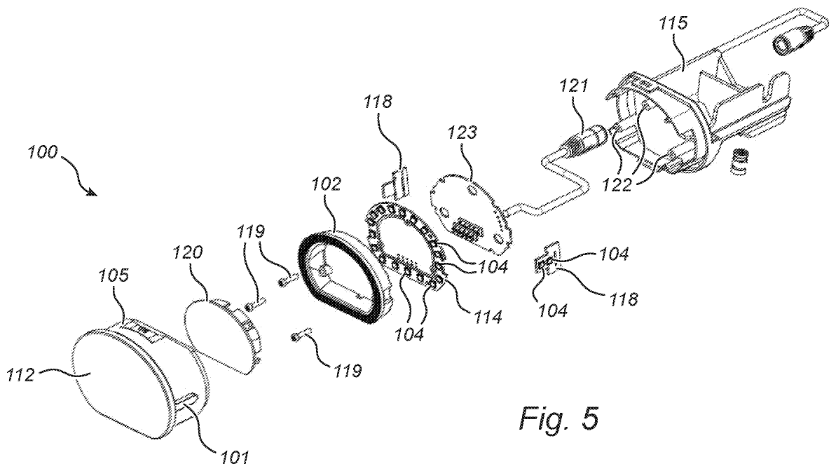

FIG. 5 shows an exploded view of a light module 100 according to the invention. In this non-limitative embodiment the light module 100 forms a rear light of a bicycle 1. Said rear light module 100 may be applied to the bicycle together with and/or separate of the front light module 100 as shown before. Also further light modules are not excluded. The rear light module 100 may be substantially similar compared to the front light module 100. That is, the module 100 comprises a module housing 105, which may comprise a rearward facing surface 112 though which a light may be emitted by one or more light sources 104. Said housing 105 may also be provided with one or more light emitting surfaces 101, such as a left emitting surface 101 and a right emitting surface 101. Said surfaces 101 configured for allowing a light to pass through when a light source 104 is turned on. The rear light module 100 further comprises a module holder 115 which may house multiple electronic and/or mechanic components of the light module 100. One of said components may for example be a connector 121. Other components of the light module 100, such as a printed circuit board 114 provided with a plurality of light sources 104, a further printed circuit board 123 and/or a diffusing element 102 may be connected to the module holder 115. Said module holder 115 is to this end provided with one or more mounting locations 122, such as a threaded hole or stud, configured for receiving one or more bolts or screws 119. Said bolts or screws 119 may pass through the diffusing element 102, and/or the printed circuit board 114, 123 to secure said elements to the module holder 115. In addition to a first printed circuit board 114, which comprises a first set of light sources 104, the light module 100 may comprise a further printed circuit board 118. Preferably said further printed circuit board 118 also comprises one or more light sources 104. Said further printed circuit board 118 may for instance be situated at an angle with respect to the first printed circuit board 114. The light sources 104 of the first printed circuit board 114 and the further printed circuit board 118 may be controlled based on a single signal received by the connector 121. Said light sources 104 preferably each being independently controllable of one another.

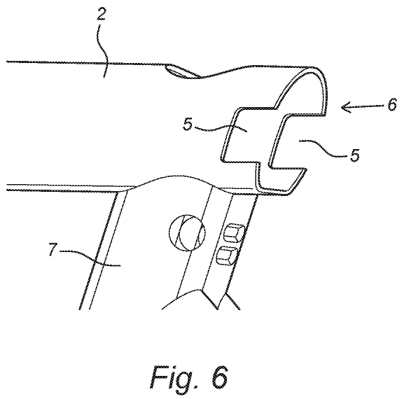

FIG. 6 shows a part of a frame of a bicycle 1, showing a top tube 2 and a seat tube 7 of the frame. The top tube comprises a receiving space 6 at a rear end thereof, for receiving a light module 100 according to the invention. Two recesses 5 are provided in the top tube 2. Said recesses 5 are configured for receiving a part of the light module 100, in particular the light emitting surfaces 101 facing sideward. As such, the light emitting surface 101 of a light module inserted into the receiving space 6 may be substantially flush with an outer surface of said upper tube 2. The recesses 5 as shown in this figure are different compared to the recesses 5 shown in FIG. 4. Hence, any number of recesses configured for receiving a light emitting surface 101 of a light module 100 may be chosen. Moreover, not only the amount of recesses 5 may be chosen arbitrarily, also the shape, since this figure indicates the recesses 5 are larger with respect to the three recesses 5 indicated in FIG. 4. Hence, also the shape of the recesses 5 is a design related aspect, as long as a part of the light emitting surface 101 of an inserted light module 100 at least partially laterally emits light. The invention relates, inter alia, to the sidewards directed light emitting surface 101 as such.

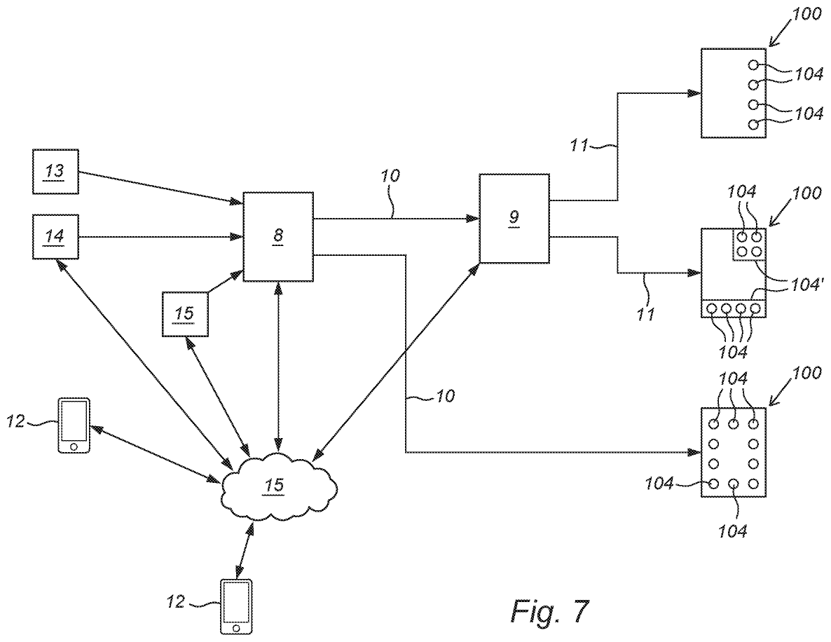

FIG. 7 shows a schematic representation of a bicycle control unit 8, 9 according to the invention. The bicycle may comprise one or more bicycle control units 8, 9, wherein the bicycle control unit is configured to independently control at least two light sources of at least one light module 100 by providing at least one light source control signal 10, 11. In this embodiment, one bicycle control unit is a central bicycle control unit 8, and an additional bicycle control unit is formed by a light module control unit 9, which is connected to the central bicycle control unit 8. Or at least in communication with said central bicycle control unit 8. The light module control unit 9 is configured for controlling at least one light source 104 of at least one light module 100. The light module control unit 9 may be located separate from the central bicycle control unit 8. Preferably, said light module control unit 9 is located in a light module 100, such that a light module control unit 9 is configured for controlling a light source 104 of a respective light module 100. Hence, the bicycle may comprise for example a single central bicycle control unit 8, and a plurality of light module control units 9, wherein preferably at least one light module control unit is located in a light module 100. In this figure however, a single light module control unit 9 is provided. The light module control unit 9 is configured for converting a primary light source control signal 10, received from the central bicycle control unit 8, into at least one secondary light source control signal 11, for independently controlling at least one light source 104. The light module control unit 9 may, based on the primary light source control signal 10 covert said signal into a plurality of secondary light source control signals 11. Preferably into one secondary light source control signal 11 for each light module 100. At least one bicycle control unit 8, 9 is configured for generating at least one light source control signal 10, 11, which comprises at least one dynamic light pattern definition, or a ground surface projection pattern. Said dynamic light pattern may for example be to sequentially and/or simultaneously illuminate a plurality of light sources 104, or a group of light sources 104′, 104″, in a predefined order and/or for a predefined period. Said at least one light source control signal 10, 11 may also comprise for example information related to a light intensity of one or more light sources 104 or a group of light sources 104′, 104″. In this figure, the middle light module 100 comprises two groups 104′, 104″ of light sources 104. Said groups 104′, 104″ may be controlled by at least one bicycle control unit 8, 9, via at least one light source control signal 10, 11. The secondary light source control signal preferably comprises a string of light source specific instructions. A secondary light source control signal directed to a specific light module 100 may as such comprise a string of light source specific instructions. Each light source 104 of said light module 100 may, upon receiving the secondary light source control signal, retrieve and/or read instructions related to said light source 104. The light source control signal 10, 11 may be based on variable inputs 12, 13, 14, 15. Preferably, at least one bicycle control unit 8, 9 is configured for receiving information from a user 13, or a portable device carried by the user 12, such as a mobile phone. Alternatively, information may be received from one or more sensors 15, such as temperature sensors, CO₂ sensors, speed sensors, torque sensors, light sensors, or the like. Yet, it is also conceivable that information is received by at least one bicycle control unit 8, 9 from the bicycle itself 14, such as bicycle characteristics, e.g., bicycle speed, acceleration, steering direction, lock status, power source status. The at least one bicycle control unit 8, 9 is configured for generating at least one light source control signal based on at least one of said inputs. Said inputs may for example communicate directly, via wire, or indirectly, via a cloud 15, with the at least one bicycle control unit 8, 9. It is conceivable that said cloud environment 15 communicates with a host computing device which is not part of the bicycle. The portable device carried by the user 12, such as the phone 12, may also communicate via the cloud environment 15 to the at least one bicycle control unit 8, 9. As such, a user may be able to control at least one light module via a phone 12.

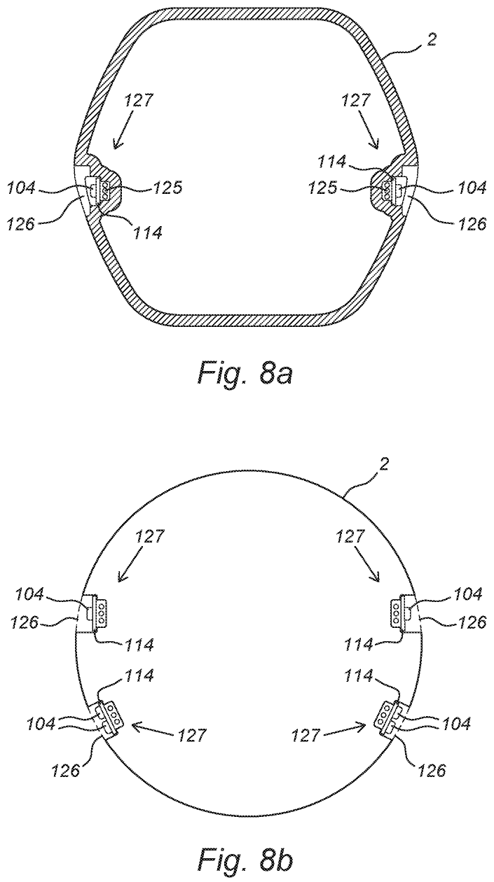

FIGS. 8a and 8b each show a cross sectional view of a top tube 2 of a bicycle 1. The two embodiments, although very similar, slightly deviate from one another. In the first embodiment as shown in FIG. 8a said top tube 2 is provided with an inwardly recessed channel 127 on the left side and right side of the top tube 2. An inner surface of said recessed channel 127 is provided with cables 125 for providing power and/or communication, i.e., control signals, to the light sources 104. Said power is provided to the light sources 104 in particular via a printed circuit board 114. The printed circuit board 114 is provided on top of the cables 125, and substantially covers said cables 125. On the printed circuit board 114 one or more light sources 104 may be arranged. It is conceivable that the channel 127 extends along a part of the top tube 2, or over the entire length thereof. It is also conceivable to apply the shown embodiment in another tube of the bicycle. In order to protect the light sources 104, the recess 127 is covered by a cover unit 126. Preferably, an exterior surface of said cover unit 126 are essentially flush with an exterior surface of the tube 2. The cover unit 126 may also protect the light sources 104 from rain or water. FIG. 8b shows an alternative embodiment, wherein the tube 2 is essentially cylindrical, and wherein each side is provided with two of inwardly recessed channels 127. It is therefore noted that the shape of the channels 127, the length of the channels 127, the amount of channels 127 may be arbitrarily chosen, and which choice remains a design related aspect. The present invention is, inter alia, related to the technical aspects of the sideward facing light sources 104 as such. FIG. 8b indicates that the lower recessed channels 127 are not only directed towards a side, but also towards the bottom, which may allow the bottom or a part of the street to be illuminated by said light sources 104 when turned on.

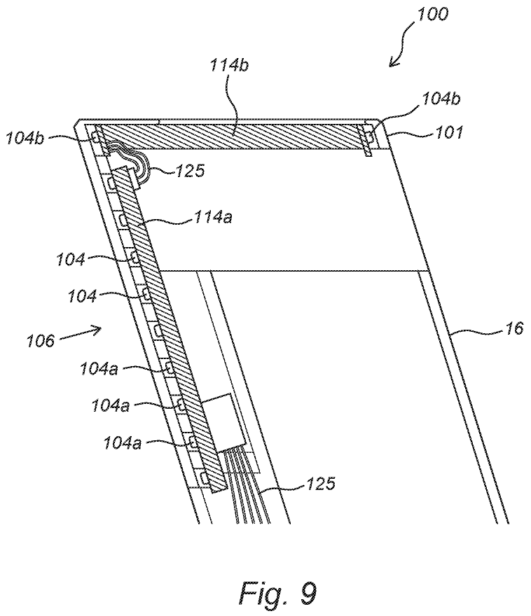

FIG. 9 shows yet another aspect of the present invention. In this figure a seat tube 16 is provided with a light module 100 according to the invention. The light module 100 comprises a first printed circuit board 114a and a second printed circuit board 114b. Said first printed circuit board 114a and second printed circuit board 114b mutually connected via wires 125. Preferably, said first printed circuit board 114a comprises a plurality of light sources 104a. At least two of said light sources 104a are oriented such that light emitted by said at least two light sources is emitted in a rearward direction, such as to form a main light beam 106. The second printed circuit board 114b may also be provided with a plurality of light sources 104b. Preferably a plane in which said two printed circuit boards 114a, 114b are situated are mutually oriented at an angle with respect to each other. It is conceivable that the second printed circuit board 114b is annular, in particular enclosing a seat post in case a seat is attached to the bicycle 1. The light sources 104 of the second printed circuit board 114b may form a substantially circular light emitting surface 101, emitting light in at least a left direction and in a right direction. Preferably said light emitting surface 101 is substantially annular, emitting in all radial directions.

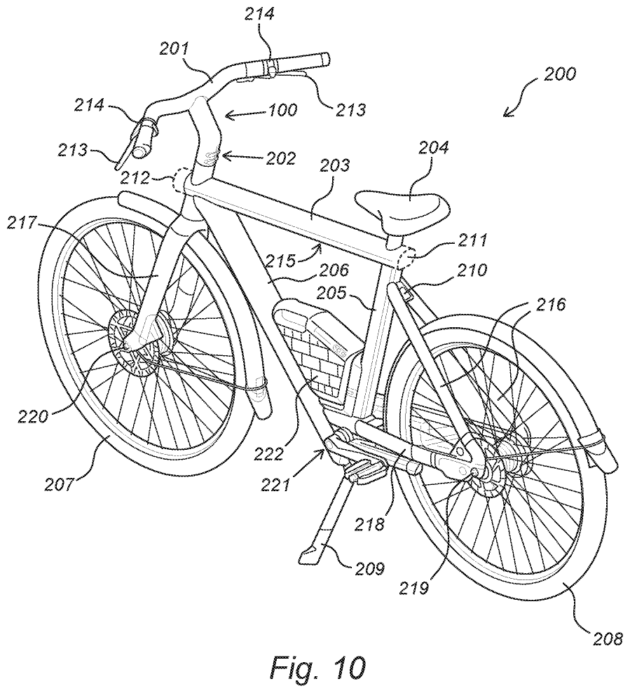

FIG. 10 shows a schematic overview of a bicycle 200 according to the invention. The bicycle 200 comprises a frame comprising a top tube 203, a seat tube 205, a bottom tube 206, a pair of seat stays 216, and a pair of chain stays 218. At the rear axis 219 a rear wheel 208 is rotatably arranged. The rear wheel may be powered by a used via a crank set 221. In order to drive de bicycle 200, the front side of the bicycle may comprise a handlebar 201, which may be rotatable with respect to the head tube 202 of the bicycle. The handlebar 201 may rotate the front wheel 207 which is arranged rotatably on a front axis 220. Said front wheel 207 may be held into place by means of the fork 217 which is rotatably coupled to the handlebar 201 of the bicycle 200. The handlebar 201 may be provided with a brake system 213 for allowing a user to apply a braking force. The handlebar 201 may comprise a first control unit 100, preferably arranged in a stem of the bicycle. Said first control unit may allow the accessory cables of the electronic accessories of the handlebar to be routed at least partially, preferably substantially entirely inside the frame of the bicycle 200. The first control unit 100 allows to reduce the amount of cables running through a steerer tube. One or more optical feedback units 214 may be arranged on and/or in the handlebar 201 for providing the user with optical feedback related to a bicycle status. Inside the bottom tube 206 a primary battery may be arranged for driving at least one electric motor which is arranged in the front axis 220 and/or rear axis 219. Optionally, a secondary battery 222 may be provided for extending the range of the bicycle 200. The primary battery inside the bottom tube 206 and/or the secondary battery 222 may be charged via a charging port 210 of the bicycle 200. The charging port 210 is arranged on a rear side of the bicycle in order to be easily accessible for a user. In this particular embodiment, the charging port 210 is arranged between the pair of seat stays 216 and attached to the seat tube 205 of the bicycle 200. In order for easily connecting the bicycle 200 to an external service device a service port 215 may be provided. In this embodiment the service port 215 is provided on a bottom side of the top tube 203 of the bicycle. Inside the top tube 203 at least one bicycle control unit may be provided. It is imaginable that at least one exposed exterior surface of at least one frame part comprises at least one antenna system. Said antenna system may be directly or indirectly mounted to said bicycle frame 202, 203, 205, 206, 216. The seat tube 205 further accommodates the seat post which may be attached to the saddle 204 of the bicycle 200. In order to increase the visibility of the user of the bicycle 200 during the evening or in the night time, the bicycle 200 may be provided with a front light module 212 and/or a rear light module 211. Said front light module 212 and rear light module 211 may allow for dynamic light patterns and/or for emitting light in at least a left and/or right direction. To this end, the light modules 211, 212 may be provided with a plurality of independently controllable light sources which may be controllable based on a light source control signal. At least two light sources of at least one light module are oriented in different directions to emit light in different directions, such as a left emittance direction and/or a right emittance direction, and/or wherein at least two light sources of at least one light module are grouped and configured to collectively generate at least one dynamic light pattern dependent on the control of said light sources by said bicycle control unit. The bicycle 200 as shown in this figure is merely illustrative for the components thereof. It is explicitly noted that some aspects of the bicycle 200 as shown in this figure may be chosen by way of design. In particular shapes of the light modules 212, 211 may at least partially be shaped by design. Moreover, the shape of the tubes 202, 203, 205, 206 of the bicycle may also at least partially be chosen by way of design. Hence, the aesthetical appearance of the depicted embodiment are matters of design choice and can be varied or eliminated as desired.

The above-described inventive concepts are illustrated by several illustrative embodiments. It is conceivable that individual inventive concepts, including inventive details, may be applied without, in so doing, also applying other details of the described example. It is not necessary to elaborate on examples of all conceivable combinations of the above-described inventive concepts, as a person skilled in the art will understand numerous inventive concepts can be (re)combined in order to arrive at a specific application and/or alternative embodiment.

The ordinal numbers used in this document, like “first”, “second”, and “third” are used only for identification purposes. Hence, the use of expressions like a “second” component, does therefore not necessarily require the co-presence of a “first” component. By “complementary” components is meant that these components are configured to co-act with each other. However, to this end, these components do not necessarily have to have complementary forms. The verb “comprise” and conjugations thereof used in this patent publication are understood to mean not only “comprise”, but are also understood to mean the phrases “contain”, “substantially consist of”, “formed by” and conjugations thereof.

It will be apparent that the invention is not limited to the working examples shown and described herein, but that numerous variants are possible within the scope of the attached claims that will be obvious to a person skilled in the art. The aesthetical appearance and design of the working examples or details thereof, in particular as shown in the appended figures, is not technically determined, unless indicated otherwise, and is merely incorporate to demonstrate and clarify the inventive concept(s) described herein. Hence, the aesthetical appearance of the depicted embodiments are matters of design choice and can be varied or eliminated as desired. The owner of this patent document does moreover not disclaim any other rights that may be lawfully associated with the information disclosed in this document, including but not limited to, copyrights and designs associated with, based upon, and/or derived from the appended figures.

1-41. (canceled)

42. A bicycle, comprising:
at least one light module said light module comprising:
a plurality of independently controllable light sources, wherein at least one independently controllable light source is, directly or indirectly, controllable based on at least one light source control signal,
at least one bicycle control unit configured to independently control at least two light sources of at least one light module by providing at least one light source control signal to said light sources and
at least one power connection, and connected to at least one independently controllable light source, for providing electric power to at least one independently controllable light source,
wherein at least two light sources of at least one light module are oriented in different directions to emit light in different directions, and/or wherein at least two light sources of at least one light module are grouped and configured to collectively generate at least one dynamic light pattern dependent on the control of said light sources by said bicycle control unit.

43. The bicycle according to claim 42, wherein the bicycle comprises a plurality of bicycle control units, wherein at least one bicycle control unit is formed by a central bicycle control unit, and wherein at least one other bicycle control unit is formed by at least one light module control unit connected to said central bicycle unit, wherein said light module control unit is configured for independently controlling at least one light source of at least one associated light module and/or wherein the at least one light module control unit is configured for converting the primary light source control signal received from the central bicycle control unit into at least one secondary light source control signal for independently controlling at least one light source.

44. The bicycle according to claim 43, wherein at least one light module control unit makes part of at least one light module.

45. The bicycle according to claim 43, wherein at least one bicycle control unit is configured to generate at least one light source control signal which comprises at least one dynamic light pattern definition, wherein said at least one light source control signal which comprises at least one dynamic light pattern definition, is configured to sequentially and/or simultaneously illuminate a plurality of light sources of at least one light module in a predefined order and/or for a predefined period of time.

46. The bicycle according to claim 45, wherein said at least one light source control signal which comprises at least one dynamic light pattern definition, is configured to vary the light intensity and/or colour temperature over time of at least one light source of at least one light module and/or wherein at least two light sources of at least one light module are grouped, and configured to collectively generate at least one dynamic light pattern based upon said at least one light source control signal which comprises at least one dynamic light pattern definition.

47. The bicycle according to claim 43, wherein at least one light source control signal comprises light source specific instructions for at least one specific light source, which are readable by said specific light source.

48. The bicycle according to claim 43, wherein at least one light source control signal comprises a string of light source specific instructions, wherein at least two independently controllable light source retrieves and/or extracts a predefined instruction associated with said light source out of the string of light source specific instructions.

49. The bicycle according to claim 43, wherein at least two independently controllable light sources are directed in substantially opposing directions respectively and/or wherein the bicycle comprises a plurality of light modules, each light module comprising a plurality of independently controllable light sources.

50. The bicycle according to claim 43, wherein at least two light sources of at least one light module are grouped, and wherein light sources of said group of light sources are independently, controllable by at least one bicycle control unit, wherein a number of the plurality of independently controllable grouped light sources is arranged to form at least a part of a circle and/or at least a part of a polygon.

51. The bicycle according to claim 50, wherein at least two, light sources of said plurality of independently controllable grouped light sources are oriented in different emittance directions, wherein at least two emittance directions enclose an angle of between 60 and 120 degrees and/or wherein at least one light module comprises a plurality of groups of independently controllable light sources, wherein the main emittance direction of at least two groups mutually differs and/or wherein at least one light module comprises a plurality of groups of independently controllable light sources, wherein one group of light sources encloses at least one of group of light sources and/or wherein at least two groups of independently controllable light sources of at least one light module are mutually separated at least by at least one mechanical part, of the bicycle and/or wherein the emittance patterns generated by at least two groups of independently controllable light sources at least partially overlap and/or coincide.

52. The bicycle according to claim 43, wherein the at least two independently controllable light sources are arranged on a substrate, wherein said substrate is a curved substrate.

53. The bicycle according to claim 43, wherein the bicycle control unit is configured to generate at least one light source control signal based upon input received from a user and/or a portable device carried by said user and/or wherein the bicycle control unit is configured to generate at least one light source control signal based upon at least one bicycle related characteristic, the bicycle acceleration, the bicycle steering direction, the status of a bicycle lock, and the status a bicycle power source.

54. The bicycle according to claim 43, wherein the bicycle control unit is configured to generate at least one light source control signal based upon at least one environmental related characteristic.

55. The bicycle according to claim 43, wherein the bicycle comprises at least one power source, to provide power to said at least one power connection.

56. The bicycle according to claim 43, wherein the light module comprises at least one light module housing, said housing defining at least one accommodating space for at least partially accommodating one or more light sources.

57. The bicycle according to claim 43, wherein the bicycle comprises a frame comprising a plurality of interconnected frame elements, which frame elements are formed by at least a seat tube element, a top tube element, a down tube element, a head tube element, at least one seat stay, at least one handlebar, and/or at least one chain stay, wherein the at least one light module is at least partially received by at least one frame element, wherein at least a part of at least one frame element, comprises at least one recessed channel, for accommodating therein the at least one strip shaped light module, wherein said recessed channel is provided on an exterior side of the top tube element and/or bottom tube element, and wherein the at least one light module accommodated in said recessed channel is at least partially covered by a substantially transparent or translucent covering material, such that an exterior surface of said covering material is substantially flush with respect to an exposed adjacent exterior surface of the top tube element and/or bottom tube element.

58. The bicycle according to claim 43, wherein the bicycle comprises at least one sensor, wherein at least one bicycle control unit, is configured for generating at least a part of the light source control signal based on data from the at least one sensor.

59. A light module for use in a bicycle according to claim 43.

60. A bicycle control unit programmed to independently control a plurality of light sources of at least one light module for use in a bicycle according to claim 43.

61. An assembly of at least one light module according to claim 59 and at least one bicycle control unit.
